(19) United States
(12) Patent Application Publication
(10) Pub. No.: US 2024/0137948 A1
(43) Pub. Date: Apr. 25, 2024

(54) RESOURCE SWITCHING METHOD FOR WIRELESS COMMUNICATIONS

(71) Applicant: ZTE CORPORATION, Shenzhen (CN)

(72) Inventors: Wei CAO, Shenzhen (CN); Nan ZHANG, Shenzhen (CN); Jianqiang DAI, Shenzhen (CN)

(73) Assignee: ZTE CORPORATION, Shenzhen (CN)

(21) Appl. No.: 18/351,019

(22) Filed: Jul. 11, 2023

Related U.S. Application Data
(63) Continuation of application No. PCT/CN2021/077927, filed on Feb. 25, 2021.

(51) Int. Cl. H04W 72/232; H04B 7/06; H04W 72/044; H04W 76/20

(52) U.S. Cl. CPC H04W 72/232; H04B 7/06968; H04W 72/046; H04W 76/20

(57) ABSTRACT

A wireless communication method for use in a wireless terminal is disclosed. The method comprises receiving, from a wireless network node, downlink control information based on an identifier of a group of wireless terminals, wherein the downlink control information comprises at least one set of beam resource related indications.

This application is a continuation of PCT/CN2021/077927, filed Feb. 25, 2021, the content of which is incorporated herein by reference in its entirety.

### TECHNICAL FIELD

This document is directed generally to wireless communications, and in particular to a resource switching method for wireless communications.

### BACKGROUND

With the development of the new radio (NR) access technologies (i.e., 5G), a broad range of use cases including enhanced mobile broadband, massive machine-type communications (MTC), critical MTC, etc., are realized. To expand the utilization of the NR access technologies, 5G connectivity via satellites is considered as a promising application. In contrast to the terrestrial networks where all communication nodes (e.g., base stations) are located on the earth, a wireless communication network incorporating satellites and/or airborne vehicles to perform some or all of the functions of terrestrial base stations is named non-terrestrial network (NTN).

### SUMMARY

In the NTNs, the coverage of a satellite is generally implemented by multiple beams. The beams of the satellite change its serving area on the ground with the movement of the satellite along its orbit. To achieve high throughput, resource (e.g., frequency/time/polarization) reuse among the beams is generally adopted. For a fixed user equipment (UE), the fixed UE is served by different beams over time and the UE needs to switch to different resources of the corresponding serving beam.

The coverage of the satellite is generally much larger than that of a terrestrial cell. For example, a footprint diameter of a single satellite beam could be hundreds of kilometers or even larger. In this huge coverage, the number of UEs would be significant too. If the network informs each UE about the serving resource changes, the signaling overhead would be high due to the significant number of UEs in the coverage.

This document relates to methods, systems, and devices for wireless communications, and in particular to methods, systems, and devices for resource switching of wireless communications.

The present disclosure relates to a wireless communication method for use in a wireless terminal. The method comprises receiving, from a wireless network node, downlink control information based on an identifier of a group of wireless terminals, wherein the downlink control information comprises at least one set of beam resource related indications.

Various embodiments may preferably implement at least some of the following features:

Preferably or in some embodiments, the wireless communication method further comprises applying at least one beam resource of a set of beam resource related indications corresponding to the wireless terminal in the at least one set of beam resource related indications for communications with the wireless network node.

Preferably or in some embodiments, the group of wireless terminals comprises all wireless terminals in a serving cell of the wireless network node.

Preferably or in some embodiments, the group of wireless terminals is one of a plurality of groups of wireless terminals in a serving cell of the wireless network node.

Preferably or in some embodiments, the identifier is calculated based on a group index of the wireless terminal.

Preferably or in some embodiments, the downlink control information comprises a group index associated with the at least one set of beam resource related indications.

Preferably or in some embodiments, the group index is mapped to a sequence of the at least one set of beam resource related indications.

Preferably or in some embodiments, the set of beam resource related indications comprises at least one of a frequency resource identifier, a transmission configuration indication state identifier, a carrier frequency offset or a polarization indicator.

Preferably or in some embodiments, the set of beam resource related indications comprises the frequency resource identifier, wherein the method further comprises performing a communication by using a frequency resource corresponding to the frequency resource identifier.

Preferably or in some embodiments, the set of beam resource related indications comprises the TCI state identifier and the method further comprises at least one of:
applying a quasi-colocation assumption provided by a TCI state corresponding to the TCI state identifier to a reception of at least one of a physical downlink control channel, a physical downlink shared channel, a periodic channel state information reference signal, a semi-persistent channel state information reference signal, an access point channel state information reference signal, or a demodulation reference signal,
applying a quasi-colocation assumption provided by a TCI state corresponding to the TCI state identifier to a transmission of at least one of a sounding reference signal, a physical uplink control channel, a physical uplink shared channel or a physical random access channel; or
performing a communication by using the same frequency resource associated with a reference signal included in a configuration of a TCI state corresponding to the TCI state identifier.

Preferably or in some embodiments, the set of beam resource related indications comprises the carrier frequency offset and the method further comprises performing a communication by applying a synchronization according to the carrier frequency offset.

Preferably or in some embodiments, the set of beam resource related indications comprises the polarization indicator and the method further comprises performing communications by using a polarization indicated by the polarization indicator.

Preferably or in some embodiments, the downlink control information is one of a new radio downlink control information format, a narrow band internet of things downlink control information format or an enhanced machine type communication downlink control information format.

Preferably or in some embodiments, the downlink control information is received at a slot n, where n is an integer and the method further comprises at least one of:
monitoring a downlink transmission on at least one beam resource of a set of beam resource related indications corresponding to the wireless terminal no earlier than a slot (n+m), wherein m is an integer determined based on a capability of the wireless terminal switching the at least one beam resource, or
transmitting an uplink transmission on at least one beam resource of a set of beam resource related indications corresponding to the wireless terminal no earlier than a slot (n+K_offset+l), wherein l is an integer determined based on a capability of the wireless terminal switching the at least one beam resource, and K offset refers to an additional scheduling offset which is configured by the wireless network node.

Preferably or in some embodiments, the wireless communication method further comprises:
receiving, from the wireless network node, a switching request indicating a timing of applying at least one beam resource of a set of beam resource related indication corresponding to the wireless terminal in the at least one set of beam resource related indications for communications, and
applying the at least one beam resource of the set of beam resource related indication corresponding to the wireless terminal at the timing,
wherein the switching request is received via a wireless terminal specific downlink control information configured for the wireless terminal or the latest switching request received from the wireless network node.

Preferably or in some embodiments, the at least one set beam resource related indications is associated with at least one of an uplink communication or a downlink communication.

The present disclosure relates to a wireless communication method for use in a wireless network node. The method comprises transmitting, to a wireless terminal, downlink control information based on an identifier of a group of wireless terminals, wherein the downlink control information comprises at least one set of beam resource related indications.

Various embodiments may preferably implement the following features:

Preferably or in some embodiments, the wireless communication method further comprises applying at least one beam resource of a set beam resource related indications corresponding to the wireless terminal in the at least one set of beam resource related indications for communications with the wireless terminal.

Preferably or in some embodiments, the group of wireless terminals comprises all wireless terminals in a serving cell of the wireless network node.

Preferably or in some embodiments, the group of wireless terminals is one of a plurality of groups of wireless terminals in a serving cell of the wireless network node.

Preferably or in some embodiments, the identifier is calculated based on a group index associated with the wireless terminal.

Preferably or in some embodiments, the downlink control information comprises a group index associated with the at least one set of beam resource related indications.

Preferably or in some embodiments, the group index is mapped to a sequence of the at least one set of beam resource related indications.

Preferably or in some embodiments, the set of beam resource related indications comprises at least one of a frequency resource identifier, a transmission configuration indication, TCI, state identifier, a carrier frequency offset or a polarization indicator.

Preferably or in some embodiments, the set of beam resource related indications comprises the frequency resource identifier and the method further comprises performing a communication with the wireless terminal by using a frequency resource corresponding to the frequency resource identifier.

Preferably or in some embodiments, the set of beam resource related indications comprises the TCI state identifier and the method further comprises at least one of:
applying a quasi-colocation assumption provided by a TCI state corresponding to the TCI state identifier to a transmission of at least one of a physical downlink control channel, a physical downlink shared channel, a periodic channel state information reference signal, a semi-persistent channel state information reference signal, an access point channel state information reference signal, or a demodulation reference signal,
applying a quasi-colocation assumption provided by a TCI state corresponding to the TCI state identifier to a reception of at least one of a sounding reference signal, a physical uplink control channel, a physical uplink shared channel or a physical random access channel, or
performing a communication with the wireless terminal by using the same frequency resource associated with a reference signal included in a configuration of a TCI state corresponding to the TCI state identifier.

Preferably or in some embodiments, the set of beam resource related indications comprises the carrier frequency offset and the method further comprises performing a communication by applying a synchronization according to the carrier frequency offset.

Preferably or in some embodiments, the set of beam resource related indications comprises the polarization indicator and the method further comprises performing a communication by using a polarization indicated by the polarization indicator.

Preferably or in some embodiments, the downlink control information is one of a new radio downlink control information format, a narrow band internet of things downlink control information format or an enhanced machine type communication downlink control information format.

Preferably or in some embodiments, at least one beam resource of a set of beam resource related indication corresponding to the wireless terminal in the at least one set of beam resource related indications is applied at a slot i, wherein i is an integer and the method further comprises transmitting the downlink control information no later than a slot (i-j), wherein j is an integer determined based on the longest propagation delay of the group of wireless terminals.

Preferably or in some embodiments, the wireless communication method comprises:
transmitting, to the wireless terminal, a switching request indicating a timing of applying at least one beam resource of a set of a beam resource related indication corresponding to the wireless terminal in the at least one set of beam resource related indications for communications, and
applying the at least one beam resource of the set of the beam resource related indications corresponding to the wireless terminal at the timing,
wherein the switching request is transmitted via a wireless terminal specific downlink control information configured for the wireless terminal or the latest switching request transmitted to the wireless terminal.

Preferably or in some embodiments, the at least one set of beam resource related indications is associated with at least one of an uplink communication or a downlink communication.

The present disclosure relates to a wireless terminal. The wireless terminal comprises a communication unit, configured to receive, from a wireless network node, downlink control information based on an identifier of a group of wireless terminals, wherein the downlink control information comprises at least one set of beam resource related indications.

Various embodiments may preferably implement the following feature:

Preferably or in some embodiments, the wireless terminal further comprises a processor configured to perform any of aforementioned wireless communication methods.

The present disclosure relates to a wireless network node. The wireless network node comprises a communication unit, configured to transmit, to a wireless terminal, downlink control information based on an identifier of a group of wireless terminals, wherein the downlink control information comprises at least one set of beam resource related indications.

Various embodiments may preferably implement the following feature:

Preferably or in some embodiments, the wireless terminal further comprises a processor configured to perform any of aforementioned wireless communication methods.

The present disclosure relates to a computer program product comprising a computer-readable program medium code stored thereupon, the code, when executed by a processor, causing the processor to implement a wireless communication method recited in any one of foregoing methods.

The example embodiments disclosed herein are directed to providing features that will become readily apparent by reference to the following description when taken in conjunction with the accompany drawings. In accordance with various embodiments, example systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the example embodiments and applications described and illustrated herein. Additionally, the specific order and/or hierarchy of steps in the methods disclosed herein are merely example approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

### BRIEF DESCRIPTION OF THE DRAWINGS

FIG. 1 shows a schematic diagram of beams and cells in new radio systems according to an embodiment of the present disclosure.

FIG. 2 shows a schematic diagram of a frequency reuse scheme in high throughput satellite systems according to an embodiment of the present disclosure.

FIG. 3 shows a schematic diagram of a mapping between beams and bandwidth parts according to an embodiment of the present disclosure.

FIG. 4 shows a schematic diagram of time-based resource switching according to an embodiment of the present disclosure.

FIG. 5 shows a schematic diagram of the resource indication according to an embodiment of the present disclosure.

FIG. 6 shows a schematic diagram of the resource indication according to an embodiment of the present disclosure.

FIG. 7 shows a flowchart of a method according to an embodiment of the present disclosure.

FIG. 8 shows a flowchart of a method according to an embodiment of the present disclosure.

FIG. 9 shows an example of a schematic diagram of a wireless terminal according to an embodiment of the present disclosure.

FIG. 10 shows an example of a schematic diagram of a wireless network node according to an embodiment of the present disclosure.

### DETAILED DESCRIPTION

In the present disclosure, a transmission resource switching method is proposed to reduce corresponding signaling overhead in NTN scenarios.

The proposed method may include at least one of the following features:
1. Defining new N-RNTI or N-RNTI-groupx for common downlink control information (DCI) based resource switching.
2. The new contents in the common DCI with CRC scrambled by the new N-RNTI/N-RNTI-groupx to support group resource switching are described, wherein the new contents which may include a group index, bandwidth part (BWP) identifier(s) (ID(s)), transmission configuration indication (TCI) state ID(s), carrier frequency offset (CFO) indicator(s), polarization indicator(s).
3. Resource switching indication timing at the base station (BS) side may take the propagation delay into account and the resource switching delay applied at the UE side should take the UE capability into account.
4. The uplink (UL) and downlink (DL) resource switching may be switched together in single common DCI.

The introduction of the beam and the BWP in the NR systems is exemplified in the following:

In the NR systems, the beam operation is involved because of high frequency usage. The beam may not be indicated by an explicit ID and may be reflected in many aspects such as Synchronization Signal Block (SSB), Channel State Information-reference signal (CSI-RS) and other similar reference signals.

In the NR systems, the BWP allows the UE with a small bandwidth transceiver to communicate with the BS with a large system bandwidth. The BWP switching may be carried out by at least one of:
A. Radio resource control (RRC) reconfiguration
B. bwp-InactivityTimer
C. Physical DL control channel (PDCCH) DCI format 0_1 or 1_1
D. Radom access channel (RACH) based fallback

The beam deployment in current NR and high throughput satellite (HTS) systems is described in the following:

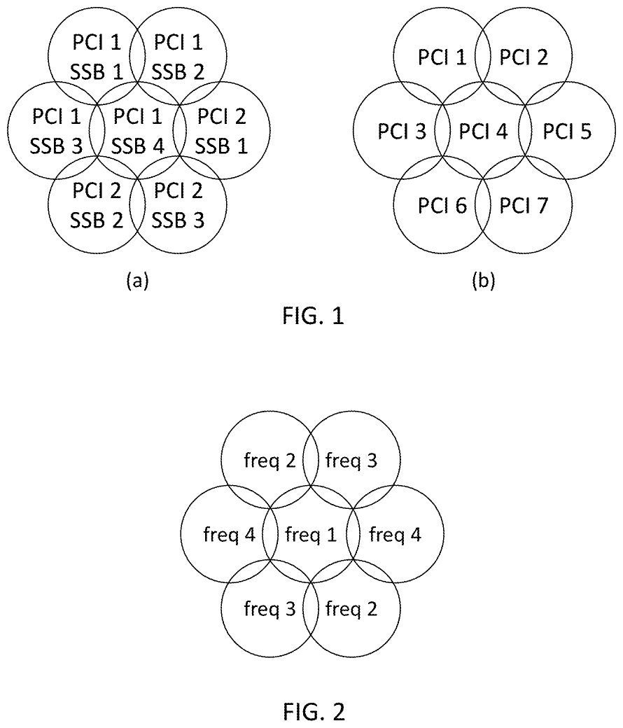

In the NR systems, a cell may have single beam or multiple beams as shown in FIG. 1, wherein each circle is a serving area (e.g., cell) of one beam. In (a), the movement of a UE among beams marked by physical cell ID (PCI) 1 can be dealt with intra-cell beam switching, which involves physical layer signaling. In (b), the movement of a UE among beams leads to inter-cell handover, which involves higher signaling cost including physical layer and higher layers.

In the HTS systems, the frequency reuse, e.g., four-color reuse shown in FIG. 2, is a common way to improve efficiency. Due to the movement of the satellite, a fixed UE will be served by different beams with different frequencies (e.g., frequencies freq 1, freq 2, freq 3 and freq 4 shown in FIG. 2) over time. In this case, an appropriate relationship between cell/beam/frequency would be needed to save the signaling cost in the mobility management. Furthermore, the time and polarization may also be used in the resource reuse scheme.

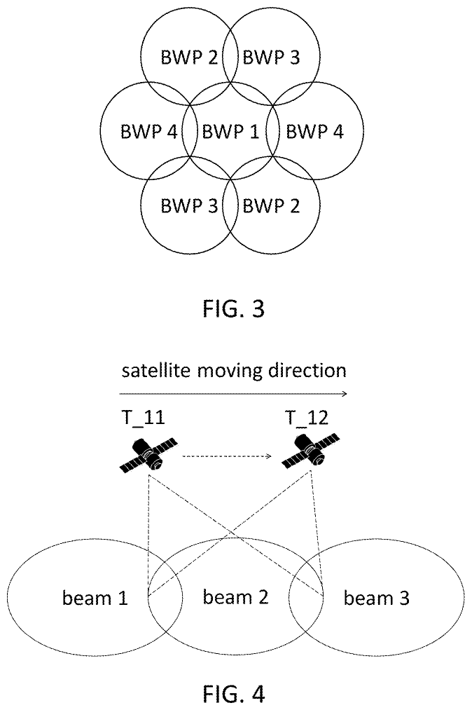

From the viewpoint of signaling cost in the mobility management for the NTN scenarios, the beam switching (e.g., FIG. 1 (a)) may a better choice than the handover (e.g., FIG. 1 (b)). On the other hand, in order to achieve the high efficiency, the frequency reuse (e.g., FIG. 2) may be used in the NTN deployment. In a nutshell, the beam switching and the resource (e.g., frequency and/or time/polarization) change may jointly happen in a typical NTN application. The synergy between the beam switching and the resource change may be supported by bundling the beam(s) and the resource(s). For example, a typical four-color frequency reuse and corresponding BWP mapping example is given in FIG. 3 for the NR NTN scenarios. Similarly, the BWPs shown in FIG. 3 (i.e., BWP 1, BWP 2, BWP 3 and BWP 4) may be replaced by carriers (e.g., anchor and non-anchor carriers in the narrow bands internet of things (NB-IoT)) or narrow bands (in enhanced machine type communication (eMTC)) in other wireless communication systems.

In the present disclosure, the resource types used in communication systems include at least one of:
1. Spatial domain resource, e.g., beams. The identifiers (IDs) of beams further include beam-specific reference signals, antenna ports, quasi-co-location configurations, precoders.
2. Frequency domain resource, e.g., a portion of available bandwidth (e.g., BWP), or anchor/non-anchor carrier in the NB-IoT, different narrow bands in the eMTC.
3. Time domain resource, e.g., different frames/slots.
4. Polarization domain resource, for example, left hand circular polarization (LHCP) or right-hand circular polarization (RHCP).

In the present disclosure, the switching among sets of resources includes at least one of:
1. Switching a single type of resource, for example:
   A. Switching from one beam to another beam, which means that a UE changes its monitored beam-specific reference signal or receives/transmits signaling with different Quasi-collocation indication.
   B. Switching among carriers (including different BWPs, anchor/non-anchor carriers or narrow bands), which means that a UE changes its used frequency domain resource.
   C. Switching from the LHCP to the RHCP, which means that a UE changes its transmission/reception polarization type.
2. Switching multiple types of resource, for example:
   A. By resource association: At least two resources (e.g., the beam and the BWP) are associated together and the switching of one of associated resources leads to the switching of all associated resources. The association can be achieved via the following:
      a) Including the index of one type of resource as part of configuration parameters of another type of resource
      b) Using additional parameters to indicate the relationship of the resource association
   B. By resource set configuration: For example, one resource set A compromises beam 1 and BWP 2 and another one resource set B compromises beam 2 and BWP 3. The switching from the resource set A to the resource set B leads to switching of both the beam and the BWP defined by each resource set.

In the present disclosure, a group identifier (ID) may be equal to a group index.

### Embodiment 1: Common DCI for Resource Switching

Case-0: Grouping Method

1. Time Based Resource Switching

For the satellite/high attitude pseudo satellite (HAPS) with earth fixed beam, a steerable serving beam provides a relatively long service link serving time. The serving time of a beam is pre-calculated by the base station (BS) as a time interval [T_xx1, T_xx2], where xx refers to a satellite index. Since the beam switching happens at T_xx2, all the UEs in the current serving area of the corresponding beam should be informed, e.g., for beam switching.

FIG. 4 shows a schematic diagram of time-based resource switching according to an embodiment of the present disclosure. In FIG. 4, a satellite indexed 1 (i.e., satellite 1) has a serving time interval of [T_11, T_12] for a beam 2. After T_12, a new satellite indexed 2 (i.e., satellite 2) takes over the beam 2 with a new serving time interval of [T_21, T_22]. In an embodiment, it is assumed that the satellite 1 uses resource (set) 1 and the satellite 2 uses resource (set) 2 for the beam 2. Under such conditions, the time intervals [T_11, T_12], [T_21, T_22], the resource 1 and the resource 2 are indicated to the UEs in the serving area of the beam 2 during the serving time interval [T_1, T_12] of the satellite 1.

In this case, all the UEs in the serving area of the beam 2 switch their resource as a group. An NTN common RNTI (N-RNTI) may be defined as a group ID for all the UEs in the serving area of single given beam.

2. Location Based Resource Switching

For the satellite/HAPS with earth moving beam, a beam sweeps a serving area with the movement of the satellite. The UEs in this serving area are switched to the next beam gradually. Therefore, the UEs in the serving area may be divided into groups and be switched per group.

If a UE with a Global Navigation Satellite System (GNSS) reports its location to the BS, the UE may be assigned with a group index from the BS for the following per group resource switching. Under such conditions, an NTN common RNTI (N-RNTI) may be defined for indicating the resource switching to a group of NTN UEs. The group ID may be included in downlink control information (DCI) with a cyclic redundancy check (CRC) scrambled by the N-RNTI. As an alternative, the group ID may be implicitly indicated by the N-RNTI itself.

### Case-1: Definition of RNTI for DCI

In order to conduct the resource switching, a new DCI may be defined in the NTN scenarios.

### Option 1:

A common RNTI (e.g., N-RNTI) may be defined. For example, a reserved value of FFFD_{HEX} in the current RNTI definition may be defined as the common RNTI. The RNTI definition comprising the common RNTI may be shown as the following table:

| Value (hexa-decimal) | RNTI |
|---|---|
| 0000 | N/A |
| 0001 - FFF2 | RA-RNTI, MSGB-RNTI, Temporary C- |
| | RNTI, C-RNTI, CI-RNTI, MCS-C-RNTI, |
| | CS-RNTI, TPC-PUCCH-RNTI, TPC- |
| | PUSCH-RNTI, TPC-SRS-RNTI, INT- |
| | RNTI, SFI-RNTI, SP-CSI-RNTI, PS-RNTI, |
| | SL-RNTI, SLCS-RNTI SL Semi-Persistent |
| | Scheduling V-RNTI, and AI-RNTI |
| FFF3-FFFC | Reserved |
| FFFD | N-RNTI |
| FFFE | P-RNTI |
| FFFF | SI-RNTI |

In this embodiment, all the UEs (e.g., the UE in the same serving area or serving cell of the beam) monitor the DCI with the CRC scrambled by the pre-defined N-RNTI. If the serving time interval [T_xx1, T_xx2] of a beam is indicated by the BS, the DCI monitoring timing is up to the UE implementation. Note that, the DCI monitoring timing should be earlier than T_xx2. The network may also trigger the DCI monitoring by the RRC configuration, to guarantee a reliable reception for the resource switching indication.

### Option 2:

If the UEs in the serving area of a beam are divided into more than one group, group-specific RNTIs may be defined. The group index may implicitly be carried (e.g., indicated) by the corresponding group-specific RNTI. The following table of the RNTI definition shows an embodiment of 4 group-specific N-RNTIs N-RNTI-group1 to N-RNTI-group4:

| Value (hexa-decimal) | RNTI |
|---|---|
| 0000 | N/A |
| 0001 - FFF2 | RA-RNTI, MSGB-RNTI, Temporary C- |
| | RNTI, C-RNTI, CI-RNTI, MCS-C-RNTI, |
| | CS-RNTI, TPC-PUCCH-RNTI, TPC- |
| | PUSCH-RNTI, TPC-SRS-RNTI, INT- |
| | RNTI, SFI-RNTI, SP-CSI-RNTI, PS-RNTI, |
| | SL-RNTI, SLCS-RNTI SL Semi-Persistent |
| | Scheduling V-RNTI, and AI-RNTI |
| FFF3-FFF0 | Reserved |
| FFFA | N-RNTI-group1 |
| FFFB | N-RNTI-group2 |
| FFFC | N-RNTI-group3 |
| FFFD | N-RNTI-group4 |
| FFFE | P-RNTI |
| FFFF | SI-RNTI |

In this embodiment, the network indicates the RNTI of the value N-RNTI-groupx (x=1, 2, 3, or 4) to each UE via the RRC configuration and each UE monitors the DCI with the CRC scrambled by its group-specific N-RNTI. As an alternative or in addition, the network indicates the group ID to each UE via the RRC configuration and each UE monitors the DCI with the CRC scrambled by the group-specific N-RNTI calculated based on the group ID.

In an embodiment, a DCI monitoring start time may be indicated by the BS together with the RNTI of the value N-RNTI-groupx (x=1, 2, 3, or 4). If the DCI monitoring start time is indicated by the BS, the DCI monitoring timing is decided based on the UE implementation. Note that, the DCI monitoring timing should start earlier than the indicated DCI monitoring start time. As an alternative or in addition, the network may also trigger the DCI monitoring by the RRC configuration to guarantee a reliable reception of the resource switching indication.

### Case-2: Contents Included in DCI

At least one of following contents may be included in the NTN-specific DCI:

1. Group Index

The group index is configured to the UE via the RRC signaling. The group index may use |log₂(N_{group})| bits with range of [0, N_{group}−1], wherein N_{group} refers to the number of UE groups. The value of N_{group} depends on the size of the serving area of single beam and the size of overlapping areas between the beam and neighboring beams. Generally, a few bits (e.g., 2 bits) may be enough.

In an embodiment, if a UE receives the DCI format including the group index, the UE compares the received group index with the assigned group index of the UE. If these two group indexes are the same, the UE switches the resource(s) to that (those) indicated in the DCI. If the two group indexes are different, the UE does not switch the resource(s).

In another embodiment, if the group index is mapped to corresponding group-specific RNTI (e.g., N-RNTI-groupx), the UE uses N-RNTI-groupx corresponding to its group index x to decode the DCI. If the DCI is decoded successfully, the UE switches the resource(s) (e.g., beam, BWP, carrier frequency, polarization) to that (those) indicated by the decoded DCI. If the DCI cannot be decoded successfully, the UE does not switch the resource(s).

In still another embodiment, the group index is implicitly contained in a sequence of resource indicators (e.g., beam, BWP, carrier frequency, polarization) and the UE in the x^{th} group uses the x^{th} element in the sequence of resource indicators to switch the resource, wherein x is the group index of the UE.

2. Bandwidth Part (BWP) Indicator

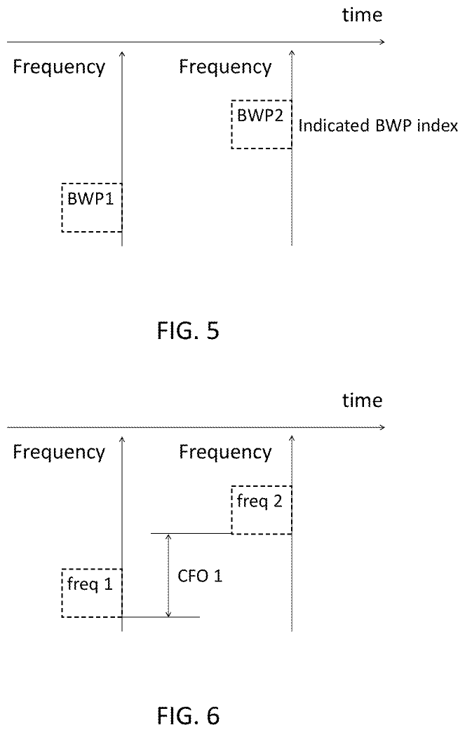

In an embodiment, a new BWP index is introduced for resource switching. FIG. 5 shows a schematic diagram of the resource indication according to an embodiment of the present disclosure. In FIG. 5, the DCI includes a BWP indicator indicating a BWP 2. When the UE receives this DCI, the UE may switch from a currently used BWP 1 to the BWP 2 indicated by (the BWP indicator in) the DCI, e.g., when the group index comprised in the DCI is equal to its own group index.

For example, the BS may use the BWP indicator to indicate the resource switching for a group of UEs. The BWP indicator may comprise 0, 1 or 2 bits which is determined based on the number n_{BWP,RRC} of DL BWPs configured by higher layers. The bit width for this field is determined as ┌log₂(n_{BWP})┐ bits, where ┌ ┐ is the ceiling function and
n_{BWP}=n_{BWP,RRC}+1, if n_{BWP,RRC}≤3, in which case the BWP indicator is equivalent to the ascending order of the higher layer parameter BWP-ID;
otherwise n_{BWP}=n_{BWP,RRC}, in which case the bandwidth part indicator is defined as the following table:

| Value of BWP indicator field | |
|---|---|
| 2 bits | BWP |
| 00 | Configured BWP with BWP-ID = 1 |
| 01 | Configured BWP with BWP-ID = 2 |
| 10 | Configured BWP with BWP-ID = 3 |
| 11 | Configured BWP with BWP-ID = 4 |

In another example, the BS may use BWP indicator to indicate resource switching for multiple groups of UEs. The BWP indicator may comprise a sequence of BWP IDs, each of which uses 0, 1 or 2 bits as determined by the number of DL BWPs n_{BWP,RRC} configured by the higher layers. The UEs in the same group share the n_{BWP,RRC} with the same value. The bit width for this field is determined as ┌log₂(n_{BWP})┐×N_{group} bits, where n_{BWP} is defined as the above and N_{group} is a pre-defined fixed value or is provided in the corresponding DCI.

3. Transmission Configuration Indication (TCI) State ID

In an embodiment, the BS may use the TCI state ID to indicate the resource switching for a group of UEs. The TCI state ID can be 0 or L bits. The TCI state ID uses 0 bit if a higher layer parameter tci-PresentInDCI is not enabled and/or the field “BWP indicator” exists; otherwise the TCI state ID uses L bits. The bit width L is determined as ┌log₂(n_{TCI})┐ bits, where ┌ ┐ is the ceiling function and n_{TCI} is the number of TCI states indicated to the UE. The UEs in the same group share the n_{TCI} of the same value.

In an example, the BS may use TCI state ID to indicate the resource switching for multiple groups of UEs. the TCI state ID may comprise a sequence of TCI state IDs, wherein the sequence uses 0 bit if the higher layer parameter tci-PresentInDCI is not enabled and/or the field “BWP indicator” exists; otherwise the sequence uses L×N_{group} bits. The bit width L is determined as ┌log₂(n_{TCI})┐ bits, where ┌ ┐ is the ceiling function and n_{TCI} is the number of TCI states indicated to the UE and N_{group} is a pre-defined fixed value or is provided in the corresponding DCI. The UEs in a group share the n_{TCI} of the same value.

Note that, the TCI state ID configured for the UE (or group of UEs) in the DCI may be applied to multiple channels of the UE (or group of UEs).

For example, when the UE switches its resource according to the TCI state ID (i.e., the TCI state corresponding to (e.g. having) the configured TCI state ID), the indicated resource (e.g., quasi-colocation QCL assumption of the TCI state corresponding to (e.g., having) the indicated TCI state ID) may apply to a reception of at least one of its physical downlink control channel (PDCCH), a period channel state information reference signal (P-CSI-RS), a semi-persistent channel state information reference signal (SP-CSI-RS) an access point channel state information reference signal (AP-CSI-RS) or a demodulation reference signal (DM-RS) and/or a transmission of at least one of a sounding reference signal (SRS), a physical uplink control channel (PUCCH), a physical uplink shared channel (PUSCH) or a physical random access channel (PRACH).

As an alternative or in addition, when the UE switches its resource according to the TCI state ID (i.e., the TCI state corresponding to (e.g., having) the configured TCI state ID), the frequency resource used in subsequent communications (i.e., transmissions/receptions) is the same with the frequency resource used by the reference signal included in the TCI state. The frequency resource used by the reference signal may locate in a BWP different from currently used BWP. Thus, the resource switching based on the TCI state ID may be a BWP switching.

In an embodiment, the configuration of TCI states may be transmitted by RRC signaling. The selection of TCI state IDs may be done by MAC CE signaling. The TCI state may be indicated by using the common DCI or the UE-specific DCI.

4. Carrier Frequency Offset (CFO) Indicator

The CFO indicator indicates the offset of Absolute Radio Frequency Channel Number (ARFCN) for resource switching, which is the frequency offset that the UE should apply in resource switching and/or radio frequency tuning. FIG. 6 shows a schematic diagram of the resource indication according to an embodiment of the present disclosure. In FIG. 6, the DCI comprises the CFO indicator indicating a CFO 1. Based on the indicated CFO 1, the UE switches the frequency resource currently used for the communications from a frequency freq 1 to another frequency freq 2, wherein freq 2=freq 1+CFO 1. In other words, the UE performs a communication (with the BS) by applying a synchronization according to the indicated CFO.

In an embodiment, the BS may use CFO indicator to indicate the resource switching for a group of UEs. The CFO indicator may be A bits, where A is an integer determined by ┌log₂(N_{ARFCN})┐, ┌ ┐ is the ceiling function and N_{ARFCN} is the number of Absolute Radio Frequency Channel Numbers (ARFCNs) covered by the system bandwidth of the network.

In another embodiment, the BS may use CFO indicator to indicate the resource switching for multiple groups of UEs. For example, the CFO indicator may comprise a sequence of CFOs. Each of the CFOs uses A bits, the sequence uses A×N_{group} bits, and N_{group} is a pre-defined fixed value or is provided in the same DCI.

5. Polarization Indicator

The polarization indicator indicates the polarization to be used for the resource switching. That is, the UE performs a communication (with the BS) by using the polarization indicated by the polarization indicator

In an embodiment, the BS may use the polarization indicator to indicate the resource switching for a group of UEs. The polarization indicator may be 1 bit (i.e., indicating the LHCP or the RHCP).

In another embodiment, the BS can use polarization indicator to indicate the resource switching for multiple groups of UEs. The polarization indicator may comprise a sequence of polarization indicators. Each of the polarization indicator uses 1 bit and the sequence uses 1×N_{group} bits. The N_{group} is the number of groups of the UEs and is a pre-defined fixed value or is provided in the same DCI.

6. Prioritized Combination

In an embodiment, the DCI may comprise at least one of the group index, the BWP ID, the TCI state ID, the CFO indicator or the polarization indicator.

In an embodiment, the DCI may comprise the group index and at least one of the BWP ID, the TCI state ID, the CFO indicator or the polarization indicator.

For example, the DCI may comprise {BWP ID, group index}, {TCI state ID, group index}, {CFO indicator, group index} or {polarization indicator, group index}.

### Case-3: DCI Format

For different network systems, the DCI format may refer to at least one of (1) DCI format 1_1 for the NR, (2) DCI format N2 for the NB IoT, (3) DCI format 6-2 for the eMTC or one dedicated DCI format.

### Embodiment-2 Timing in Resource Switching

### Case-0: Timing in Resource Switching

In the NTN scenarios, the propagation delay is much larger than that in the typical TN scenarios. Thus, the propagation delay should be considered in the resource switching procedure.

1. Time Based Method

For the satellite/HAPS with the earth fixed beam, the serving time of a beam is pre-calculated by the BS as a time interval [T_xx1, T_xx2], wherein xx is the index of the satellite. This serving time interval is indicated in the NTN specific system information and the resource switching request is transmitted by the BS no later than a DL slot (for the NR based NTN) or a DL subframe (for the NB-IoT and the eMTC based NTN) (n−┌T_{PropagationDelay}/Tᵤₙᵢₜ┐), wherein n is an integer, the DL slot n or the DL subframe n is the time of the BS applying the switched resource, ┌ ┐ is the ceiling function, T_{PropagationDelay} refers to the longest propagation delay from the BS to the farthest UE in the given beam, and Tᵤₙᵢₜ refers to the used time unit in the corresponding system (e.g. slot or subframe).
A. For the NR based NTN, Tᵤₙᵢₜ may be Tₛₗₒₜ (i.e., the period of a slot). After the UE receives the resource switching request (e.g., via either common DCI or UE-specific DCI) at (and/or before) the DL slot n on the current serving cell, the UE monitors DL reference signal on the new resource on the serving cell after DL slot (n+┌T_{BWPswitchDelay}┐). The value of T_{BWPswitchDelay} is determined based on the UE capability and can be inherited from the current NR specification.
B. For the NB-IoT and the eMTC based NTN, Tᵤₙᵢₜ may be T_{subframe} (i.e., the period of a subframe). After the UE receives a resource switching request (via either common DCI or UE-specific DCI) at (and/or before) DL subframe n on a serving cell, the UE should be able to monitor the DL reference signal on the new resource on the serving cell after DL frame (n+┌T_{RfreturningTime}┐). The value of T_{RfreturningTime} is determined based on the UE capability and can be inherited from current long-term evolution (LTE) specification.

2. Location Based Method

For the satellite/HAPS with the earth moving beam, the BS sends the resource switching request to the UEs in groups. The resource switching request should be transmitted by the BS for a group of UEs no later than a DL slot (for the NR based NTN) or the DL subframe (for the NB-IoT and the eMTC based NTN) (n−┌T_{PropagationDelay}/Tᵤₙᵢₜ┐), wherein n is an integer, the DL slot n or the DL subframe n is the time of the BS applying the switched resource, ┌ ┐ is the ceiling function, T_{PropagationDelay} refers to the longest propagation delay from the BS to the farthest UE in the given beam, and Tᵤₙᵢₜ refers to the used time unit in the corresponding system (e.g. slot or subframe).
A. For the NR based NTN, Tᵤₙᵢₜ may be Tₛₗₒₜ (i.e., the period of a slot). After the UE receives the resource switching request (e.g., via either common DCI or UE-specific DCI) at (and/or before) the DL slot n on the current serving cell, the UE monitors DL reference signal on the new resource on the serving cell after DL slot (n+┌T_{BWPswitchDelay}┐). The value of T_{BWPswitchDelay} is determined based on the UE capability and can be inherited from the current NR specification.
B. For the NB-IoT and the eMTC based NTN, Tᵤₙᵢₜ may be T_{subframe} (i.e., the period of a subframe). After the UE receives a resource switching request (via either common DCI or UE-specific DCI) at (and/or before) DL subframe n on a serving cell, the UE should be able to monitor the DL reference signal on the new resource on the serving cell after DL frame (n+┌T_{RfreturningTime}┐). The value of T_{RfreturningTime} is determined based on the UE capability and can be inherited from the current LTE specification.

### Case-1: Priority Rules

In an embodiment, the UE may receive more than one resource switching request (via the common DCI and the UE-specific DCI, respectively) before carrying out the resource switching. The priority rules of performing the resource switching based on which one of received resource switching requests may comprise at least one of:
A. The UE follows the resource switching request in (e.g., received via) the UE-specific DCI. That is, the timing of performing the resource switching follows the timing indicated by the corresponding UE-specific DCI.
B. The UE follows the latest resource switching request. The timing of performing the resource switching follows the timing indicated by the latest DCI.

### Embodiment-3 Resource Switching

In the NTN scenarios, the frequency division duplex (FDD) is a common choice. It is noted that the beam switching may cause both the DL and UL resource switching. In the current NR specification, the DB format-0_1 and the DCI format 1_1 may be respectively used for the UL BWP switching or DL BWP switching. In order to save the signaling cost, the DCI format 1_1 message may indicate the UL BWP switching and/or the DL BWP switching. Note that the DCI format 1_1 may be the common DCI or the UE-specific DCI.

For the common DCI, a pre-defined NTN common RNTI (N-RNTI) may be defined for the NTN scenarios. For example, the reserved value of FFFD in the current RNTI definition may be used as shown in the following table.

| Value (hexa-decimal) | RNTI |
|---|---|
| 0000 | N/A |
| 0001 - FFF2 | RA-RNTI, MSGB-RNTI, Temporary C- |
| | RNTI, C-RNTI, CI-RNTI, MCS-C-RNTI, |
| | CS-RNTI, TPC-PUCCH-RNTI, TPC- |
| | PUSCH-RNTI, TPC-SRS-RNTI, INT- |
| | RNTI, SFI-RNTI, SP-CSI-RNTI, PS-RNTI, |
| | SL-RNTI, SLCS-RNTI SL Semi-Persistent |
| | Scheduling V-RNTI, and AI-RNTI |
| FFF3-FFFA | Reserved |
| FFFD | N-RNTI |
| FFFE | P-RNTI |
| FFFF | SI-RNTI |

For the NR based NTN, the DCI format 1_1 with the CRC scrambled by the N-RNTI may include at least one of:
1. DL BWP indicator—In an embodiment, the bit width of the DL BWP indicator may be 0, 1 or 2 bits and is determined based on the number of DL BWPs n_{DL BWP,RRC} configured by the higher layers. The bit width for this field is determined as ┌log₂(n_{DL BWP})┐ bits, where ┌ ┐ is the ceiling function and
   n_{DL BWP}=n_{DL BWP,RRC}+1 if n_{DL BWP,RRC}≤3, in which case the DL BWP indicator is equivalent to the ascending order of the higher layer parameter BWP-ID;
   otherwise n_{DL BWP}=n_{DL BWP,RRC}, in which case the DL BWP indicator is defined as the following table:

| Value of DL BWP | |
|---|---|
| indicator field | |
| 2 bits | DL BWP |
| 00 | Configured DL BWP with BWP-ID = 1 |
| 01 | Configured DL BWP with BWP-ID = 2 |
| 10 | Configured DL BWP with BWP-ID = 3 |
| 11 | Configured DL BWP with BWP-ID = 4 |

2. UL BWP indicator—In an embodiment, the bit width of the UL BWP indicator may be 0, 1 or 2 bits and is determined by the number of UL BWPs n_{UL BWP,RRC} configured by the higher layers. The bit width for this field is determined as ┌log₂(n_{UL BWP})┐ bits, where ┌ ┐ is the ceiling function and
   n_{UL BWP}=n_{UL BWP,RRC}+1 if n_{UL BWP,RRC}≤3, in which case the UL BWP indicator is equivalent to the ascending order of the higher layer parameter BWP-ID;
   otherwise n_{UL BWP}=n_{UL BWP,RRC}, in which case the UL BWP indicator is defined as the following table:

| Value of UL BWP | |
|---|---|
| indicator field | |
| 2 bits | UL BWP |
| 00 | Configured UL BWP with BWP-ID = 1 |
| 01 | Configured UL BWP with BWP-ID = 2 |
| 10 | Configured UL BWP with BWP-ID = 3 |
| 11 | Configured UL BWP with BWP-ID = 4 |

In an embodiment for the NB-IoT or the eMTC based NTN, the DCI format N2 or the DCI format 6-2 with the CRC scrambled by the N-RNTI may include:
1. CFO_DL—the DL frequency offset of the ARFCN for the resource switching. The CFO DL indicates the DL carrier frequency offset that the UE should apply in resource switching.
2. CFO_UL—the UL frequency offset of the ARFCN for the resource switching. The CFO UL indicates the UL carrier frequency offset that the UE should apply in the resource switching.

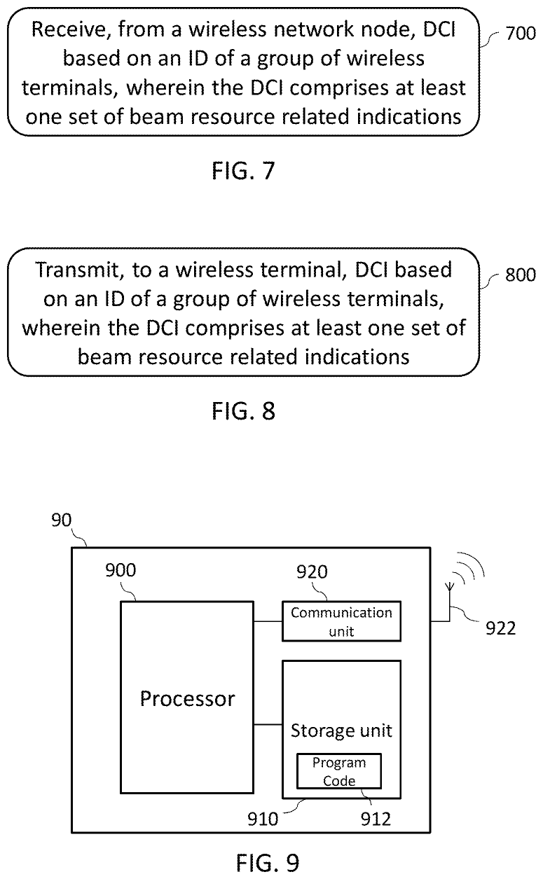

FIG. 7 shows a flowchart of a method according to an embodiment of the present disclosure. The method shown in FIG. 7 may be used in a wireless terminal (e.g., UE) and comprises the following step:

Step 700: Receive, from a wireless network node, DCI based on an ID of a group of wireless terminals, wherein the DCI comprises at least one set of beam resource related indications.

In FIG. 7, the wireless terminal receives (common) DCI based on an ID of (e.g., an ID for) a group of wireless terminals (corresponding to the wireless terminal) from a wireless network node (e.g., satellite and/or HAPS). The DCI comprises at least one set of beam resource related indications (e.g., beam resource related indication information). Note that, the ID associated with the reception of the DCI is configured for and/or shared by the group of the wireless terminals.

In an embodiment, the wireless terminal applies at least one beam resource of a set of beam resource related indications corresponding to (e.g., configured for or of) the wireless terminal in the at least one set of beam resource related indications for communications (transmissions and/or receptions) with the wireless network node. The method of the wireless terminal determines the set of beam resource related indications corresponding to the wireless terminal in the at least one set of beam resource related indications may be referred to Embodiment 1.

In an embodiment, the group of wireless terminals comprises all wireless terminals in a serving cell of the wireless network node. That is, the ID of the group of wireless terminals may be the N-RNTI.

In an embodiment, the group of wireless terminals is one of a plurality of groups of wireless terminals in a serving cell of the wireless network node. In this embodiment, the ID is calculated (e.g., determined) based on a group index associated with the wireless terminal. For instance, the ID of the group of wireless terminals may be the N-RNTI-groupx, where x is a group index of the wireless terminal.

In an embodiment, the downlink control information comprises a group index associated with the at least one set of beam resource related indications.

In an embodiment, the group index is mapped to a sequence of the at least one set of beam resource related indications. That is, the set of beam resource indications configured for the wireless terminal may be implicitly indicated by the group index of the wireless terminal and the sequence of the at least one set of beam resource related indications. For example, the beam resource related indication for the 1st group of the wireless terminals (i.e., the group index is 1) is the 1^{st} set of beam resource related indication (e.g., 1^{st} part of DCI bits) in the at least one set of beam resource related indications.

In an embodiment, the set of beam resource related indications comprises at least one of a frequency resource identifier, a TCI state ID, a CFO or a polarization indicator. The frequency resource identifier may comprise at least one of a BWP ID, a narrow band ID or a carrier ID.

In an embodiment, the set of beam resource related indications comprises the frequency resource identifier. In this embodiment, the wireless terminal performs (subsequent) communication(s) (with the wireless network node) by using a frequency resource corresponding to the frequency resource identifier.

In an embodiment, the set of beam resource related indications comprises the TCI state ID. In this embodiment, the wireless terminal may perform at least one of:
applying a quasi-colocation (QCL) assumption provided by a TCI state corresponding to the TCI state ID to a reception of at least one of a PDCCH, a PDSCH, a P-CSI-RS, a SP-CSI-RS, an AP-CSI-RS, or a DM-RS,
applying a QCL assumption provided by a TCI state corresponding to the TCI state ID to a transmission of at least one of an SRS, a PUCCH, a PUSCH or a PRACH, or
performing a communication (with the wireless network node) by using the same frequency resource associated with a reference signal included in a configuration of a TCI state corresponding to the TCI state ID.

In an embodiment, the set of beam resource related indications comprises the CFO and the wireless terminal performs a communication (with the wireless network node) by applying a synchronization according to the CFO.

In an embodiment, the set of beam resource related indications comprises the polarization indicator and the wireless terminal performs communication(s) (with the wireless network node) by using a polarization (e.g., LHCP or RHCP) indicated by the polarization indicator.

In an embodiment, the downlink control information is one of a NR-DCI format (e.g., DCI format 1_1), an NB-IoT DCI format (e.g., DCI format N2) or an eMTC DCI format (e.g., DCI format 6_2).

In an embodiment, the DCI is received at a slot n, where n is an integer. In this embodiment, the wireless terminal performs at least one of:
monitoring a downlink transmission on at least one beam resource of a set of beam resource related indications corresponding to the wireless terminal no earlier than a slot (n+m), wherein m is an integer determined based on a capability of the wireless terminal switching the at least one beam resource, or
transmitting an uplink transmission on at least one beam resource of a set of beam resource related indications corresponding to the wireless terminal no earlier than a slot (n+K_offset+l), wherein l is an integer determined based on a capability of the wireless terminal switching the at least one beam resource, and K_offset refers to an additional scheduling offset which is configured by the wireless network node.

In an embodiment, the wireless terminal receives, from the wireless network node, a switching request indicating a timing of applying a set of beam resource related indication corresponding to the wireless terminal in the at least one set of beam resource related indications for communications and applies (at least one beam resource of) the set of beam resource related indication corresponding to the wireless terminal at the timing. Note that, the switching request is received via a wireless terminal specific DCI configured for the wireless terminal or the latest switching request received from the wireless network node.

In an embodiment, the at least one set beam resource related indications is associated with at least one (e.g., both) of an uplink communication or a downlink communication.

FIG. 8 shows a flowchart of a method according to an embodiment of the present disclosure. The method shown in FIG. 8 may be used in a wireless network node (e.g., BS, satellite and/or HAPS) and comprises the following step:
Step 800: Transmit, to a wireless terminal, DCI based on an ID of a group of wireless terminals, wherein the DCI comprises at least one set of beam resource related indications.

In FIG. 8, the wireless network node transmits, to a wireless terminal (e.g., UE) DCI based on an ID of (e.g., an ID for) a group of wireless terminals (corresponding to the wireless terminal). The DCI comprises at least one set of beam resource related indications. Note that, the ID associated with the transmission of the DCI is configured for and/or shared by the group of the wireless terminals.

In an embodiment, the wireless network node applies at least one beam resource of a set beam resource related indication corresponding to the wireless terminal in the at least one set of beam resource related indications for communications with the wireless terminal.

In an embodiment, the group of wireless terminals comprises all wireless terminals in a serving cell of the wireless network node.

In an embodiment, the group of wireless terminals is one of a plurality of groups of wireless terminals in a serving cell of the wireless network node.

In an embodiment, the ID is calculated based on a group index of the wireless terminal.

In an embodiment, the DCI comprises a group index associated with the at least one set of beam resource related indications.

In an embodiment, the group index is mapped to a sequence of the at least one set of beam resource related indications.

In an embodiment, the set of beam resource related indications comprises at least one of a frequency resource identifier, a TCI state ID, a CFO or a polarization indicator.

In an embodiment, the set of beam resource related indications comprises the frequency resource identifier and the wireless network node performs a communication with the wireless terminal by using a frequency resource corresponding to the frequency resource identifier.

In an embodiment, the set of beam resource related indications comprises the TCI state identifier. In this embodiment, the wireless network node performs at least one of:
applying a QCL assumption provided by a TCI state corresponding to the TCI state ID to a transmission of at least one of a PDCCH, a PDSCH, a P-CSI-RS, an SP-CSI-RS, an AP-CSI-RS, or a DM-RS,
applying a QCL assumption provided by a TCI state corresponding to the TCI state ID to a reception of at least one of a SRS, a PUCCH, a PUSCH or a PRACH,
performing communication(s) with the wireless terminal by using the same frequency resource associated with a reference signal included in a configuration of a TCI state corresponding to the TCI state ID.

In an embodiment, the set of beam resource related indications comprises the CFO and the wireless network node performs (subsequent) communication(s) by applying a synchronization according to the CFO.

In an embodiment, the set of beam resource related indications comprises the polarization indicator and the wireless network node performs (subsequent) communication(s) by using a polarization (e.g., LHCP or RHCP) indicated by the polarization indicator.

In an embodiment, the downlink control information is one of a NR-DCI format (e.g., DCI format 1_1), an NB-IoT DCI format (e.g., DCI format N2) or an eMTC DCI format (e.g., DCI format 6_2).

In an embodiment, at least one beam resource of a set of beam resource related indication corresponding to the wireless terminal in the at least one set of beam resource related indications is applied at a slot i, wherein i is an integer. In this embodiment, the wireless network node transmits the DCI no later than a slot (i−j), wherein j is an integer determined based on the longest propagation delay of the group of wireless terminals.

In an embodiment, the wireless terminal transmits, to the wireless terminal, a switching request indicating a timing of applying a beam resource related indication corresponding to the wireless terminal in the at least one set of beam resource related indications for communications and applies the beam resource related indication corresponding to the wireless terminal at the timing. In this embodiment, the switching request is transmitted via a wireless terminal specific DCI configured for the wireless terminal or the latest switching request transmitted to the wireless terminal.

In an embodiment, the at least one set of beam resource related indications is associated with at least one (e.g., both) of an uplink communication or a downlink communication.

FIG. 9 relates to a schematic diagram of a wireless terminal 90 according to an embodiment of the present disclosure. The wireless terminal 90 may be a user equipment (UE), a mobile phone, a laptop, a tablet computer, an electronic book, or a portable computer system and is not limited herein. The wireless terminal 90 may include a processor 900 such as a microprocessor or Application Specific Integrated Circuit (ASIC), a storage unit 910 and a communication unit 920. The storage unit 910 may be any data storage device that stores a program code 912, which is accessed and executed by the processor 900. Embodiments of the storage unit 912 include but are not limited to a subscriber identity module (SIM), read-only memory (ROM), flash memory, random-access memory (RAM), hard-disk, and optical data storage device. The communication unit 920 may a transceiver and is used to transmit and receive signals (e.g., messages or packets) according to processing results of the processor 900. In an embodiment, the communication unit 920 transmits and receives the signals via at least one antenna 922 shown in FIG. 9.

In an embodiment, the storage unit 910 and the program code 912 may be omitted and the processor 900 may include a storage unit with stored program code.

The processor 900 may implement any one of the steps in exemplified embodiments on the wireless terminal 90, e.g., by executing the program code 912.

The communication unit 920 may be a transceiver. The communication unit 920 may as an alternative or in addition be combining a transmitting unit and a receiving unit configured to transmit and to receive, respectively, signals to and from a wireless network node (e.g., a base station).

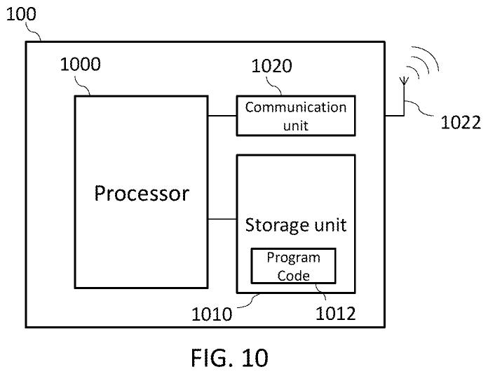

FIG. 10 relates to a schematic diagram of a wireless network node 100 according to an embodiment of the present disclosure. The wireless network node 100 may be a satellite, a HAPS, a base station (BS), a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB central unit (gNB-CU), a gNB distributed unit (gNB-DU) a data network, a core network or a Radio Network Controller (RNC), and is not limited herein. In addition, the wireless network node 100 may comprise (perform) at least one network function such as an access and mobility management function (AMF), a session management function (SMF), a user place function (UPF), a policy control function (PCF), an application function (AF), etc. The wireless network node 100 may include a processor 1000 such as a microprocessor or ASIC, a storage unit 1010 and a communication unit 1020. The storage unit 1010 may be any data storage device that stores a program code 1012, which is accessed and executed by the processor 1000. Examples of the storage unit 1012 include but are not limited to a SIM, ROM, flash memory, RAM, hard-disk, and optical data storage device. The communication unit 1020 may be a transceiver and is used to transmit and receive signals (e.g., messages or packets) according to processing results of the processor 1000. In an example, the communication unit 1020 transmits and receives the signals via at least one antenna 1022 shown in FIG. 10.

In an embodiment, the storage unit 1010 and the program code 1012 may be omitted. The processor 1000 may include a storage unit with stored program code.

The processor 1000 may implement any steps described in exemplified embodiments on the wireless network node 100, e.g., via executing the program code 1012.

The communication unit 1020 may be a transceiver. The communication unit 1020 may as an alternative or in addition be combining a transmitting unit and a receiving unit configured to transmit and to receive, respectively, signals to and from a wireless terminal (e.g., a user equipment or another wireless network node).

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand example features and functions of the present disclosure. Such persons would understand, however, that the present disclosure is not restricted to the illustrated example architectures or configurations but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described example embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general-purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general-purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according to embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein but is to be accorded the widest scope consistent with the novel features and principles disclosed herein, as recited in the claims below.

1. A wireless communication method for use in a wireless terminal, the wireless communication method comprising:
receiving, from a wireless network node, downlink control information based on an identifier of a group of wireless terminals, wherein the downlink control information comprises at least one set of beam resource related indications,
wherein the set of beam resource related indications comprises at least one of a frequency resource identifier, a transmission configuration indication (TCI) state identifier, a carrier frequency offset or a polarization indicator.

2. The wireless communication method of claim 1, wherein the downlink control information comprises a group index associated with the at least one set of beam resource related indications, and
wherein the group index is mapped to a sequence of the at least one set of beam resource related indications.

3. The wireless communication method of claim 1, wherein the set of beam resource related indications comprises the frequency resource identifier,
wherein the wireless communication method further comprises:
performing a communication by using a frequency resource corresponding to the frequency resource identifier.

4. The wireless communication method of claim 1, wherein the set of beam resource related indications comprises the TCI state identifier,
wherein the wireless communication method further comprises at least one of:
applying a quasi-colocation assumption provided by a TCI state corresponding to the TCI state identifier to a reception of at least one of a physical downlink control channel, a physical downlink shared channel, a periodic channel state information reference signal, a semi-persistent channel state information reference signal, an access point channel state information reference signal, or a demodulation reference signal,
applying a quasi-colocation assumption provided by a TCI state corresponding to the TCI state identifier to a transmission of at least one of a sounding reference signal, a physical uplink control channel, a physical uplink shared channel or a physical random access channel; or
performing a communication by using the same frequency resource associated with a reference signal included in a configuration of a TCI state corresponding to the TCI state identifier.

5. The wireless communication method of claim 1, wherein the set of beam resource related indications comprises the carrier frequency offset,
wherein the wireless communication method further comprises:
performing a communication by applying a synchronization according to the carrier frequency offset.

6. The wireless communication method of claim 1, wherein the set of beam resource related indications comprises the polarization indicator,
wherein the wireless communication method further comprises:
performing communications by using a polarization indicated by the polarization indicator.

7. The wireless communication method of claim 1, wherein the downlink control information is received at a slot n, where n is an integer,
wherein the wireless communication method further comprises at least one of:
monitoring a downlink transmission on at least one beam resource of a set of beam resource related indications corresponding to the wireless terminal no earlier than a slot (n+m), wherein m is an integer determined based on a capability of the wireless terminal switching the at least one beam resource, or
transmitting an uplink transmission on at least one beam resource of a set of beam resource related indications corresponding to the wireless terminal no earlier than a slot (n+K_offset+l), wherein l is an integer determined based on a capability of the wireless terminal switching the at least one beam resource, and K_offset refers to an additional scheduling offset which is configured by the wireless network node.

8. The wireless communication method of claim 1, further comprising:
receiving, from the wireless network node, a switching request indicating a timing of applying at least one beam resource of a set of beam resource related indication corresponding to the wireless terminal in the at least one set of beam resource related indications for communications, and
applying the at least one beam resource of the set of beam resource related indication corresponding to the wireless terminal at the timing,
wherein the switching request is received via a wireless terminal specific downlink control information configured for the wireless terminal or the latest switching request received from the wireless network node.

9. The wireless communication method of claim 1, wherein the at least one set beam resource related indications is associated with at least one of an uplink communication or a downlink communication.

10. A wireless communication method for use in a wireless network node, the wireless communication method comprising:
transmitting, to a wireless terminal, downlink control information based on an identifier of a group of wireless terminals, wherein the downlink control information comprises at least one set of beam resource related indications,
wherein the set of beam resource related indications comprises at least one of a frequency resource identifier, a transmission configuration indication (TCI) state identifier, a carrier frequency offset or a polarization indicator.

11. The wireless communication method of claim 10, wherein the downlink control information comprises a group index associated with the at least one set of beam resource related indications, and
wherein the group index is mapped to a sequence of the at least one set of beam resource related indications.

12. The wireless communication method of claim 10, wherein the set of beam resource related indications comprises the frequency resource identifier,
wherein the wireless communication method further comprises:
performing a communication with the wireless terminal by using a frequency resource corresponding to the frequency resource identifier.

13. The wireless communication method of claim 10, wherein the set of beam resource related indications comprises the TCI state identifier,
wherein the wireless communication method further comprises at least one of:
applying a quasi-colocation assumption provided by a TCI state corresponding to the TCI state identifier to a transmission of at least one of a physical downlink control channel, a physical downlink shared channel, a periodic channel state information reference signal, a semi-persistent channel state information reference signal, an access point channel state information reference signal, or a demodulation reference signal,
applying a quasi-colocation assumption provided by a TCI state corresponding to the TCI state identifier to a reception of at least one of a sounding reference signal, a physical uplink control channel, a physical uplink shared channel or a physical random access channel, or
performing a communication with the wireless terminal by using the same frequency resource associated with a reference signal included in a configuration of a TCI state corresponding to the TCI state identifier.

14. The wireless communication method of claim 10, wherein the set of beam resource related indications comprises the carrier frequency offset,
wherein the wireless communication method further comprises:
performing a communication by applying a synchronization according to the carrier frequency offset.

15. The wireless communication method of claim 10, wherein the set of beam resource related indications comprises the polarization indicator,
wherein the wireless communication method further comprises:
performing a communication by using a polarization indicated by the polarization indicator.

16. The wireless communication method of claim 10, wherein at least one beam resource of a set of beam resource related indication corresponding to the wireless terminal in the at least one set of beam resource related indications is applied at a slot i, wherein i is an integer,
wherein the wireless communication method further comprises:
transmitting the downlink control information no later than a slot (i−j), wherein j is an integer determined based on the longest propagation delay of the group of wireless terminals.

17. The wireless communication method of claim 10, further comprising:
transmitting, to the wireless terminal, a switching request indicating a timing of applying at least one beam resource of a set of a beam resource related indication corresponding to the wireless terminal in the at least one set of beam resource related indications for communications, and
applying the at least one beam resource of the set of the beam resource related indications corresponding to the wireless terminal at the timing,
wherein the switching request is transmitted via a wireless terminal specific downlink control information configured for the wireless terminal or the latest switching request transmitted to the wireless terminal.

18. The wireless communication method of claim 10, wherein the at least one set of beam resource related indications is associated with at least one of an uplink communication or a downlink communication.

19. A wireless terminal, comprising:
at least one processor configured to receive, from a wireless network node, downlink control information based on an identifier of a group of wireless terminals, wherein the downlink control information comprises at least one set of beam resource related indications,
wherein the set of beam resource related indications comprises at least one of a frequency resource identifier, a transmission configuration indication (TCI) state identifier, a carrier frequency offset or a polarization indicator.

20. A wireless network node, comprising:
at least one processor configured to transmit, to a wireless terminal, downlink control information based on an identifier of a group of wireless terminals, wherein the downlink control information comprises at least one set of beam resource related indications,
wherein the set of beam resource related indications comprises at least one of a frequency resource identifier, a transmission configuration indication (TCI) state identifier, a carrier frequency offset or a polarization indicator.
